(19) United States
(12) Patent Application Publication
(10) Pub. No.: US 2026/0148127 A1
(43) Pub. Date: May 28, 2026

(54) DEEPFAKE DETECTION USING MICROMODELING

(71) Applicant: Bank of America Corporation, Charlotte, NC (US)

(72) Inventors: Maharaj Mukherjee, Poughkeepsie, NY (US); George Albero, Charlotte, NC (US); Vinesh Patel, Greenwich (GB); James Siekman, Charlotte, NC (US); Abhijit Behera, Hyderabad (IN); Maneesh Kumar Sethia, Hyderabad (IN); Sivashalini Sivajothi, Chennai (IN)

(21) Appl. No.: 18/960,332

(22) Filed: Nov. 26, 2024

(51) Int. Cl. G06N 20/00

(52) U.S. Cl. CPC G06N 20/00

(57) ABSTRACT

Aspects related to deepfake detection using micromodeling are provided. A micromodeling platform may train a detection model to perform micromodeling. The platform may receive sample information for identification of a user. The platform may generate micromodeling information by performing micromodeling. The platform may train the detection model to output similarity scores based on input of authentication information. The platform may generate, based on an event processing request, a similarity score indicating a similarity between authentication information of the event processing request and the micromodeling information. The platform may cause display of a detection alert if the similarity score does not satisfy a threshold. The platform may indicate approval of the event processing request if the similarity score does satisfy a threshold. The platform may send a response to the event processing request. The platform may update the detection model based on sending the response to the event processing request.

### BACKGROUND

Aspects described herein are related to deepfake detection using micromodeling. In some instances, entities such as an enterprise organization (e.g., a financial institution, and/or other institutions) may utilize one or more authentication systems configured to protect access to a network and/or access to information managed by, for example, the enterprise organization. The authentication systems may be configured to attempt to detect technologies, known as “deepfake” technologies, that allow a threat actor to impersonate a user by copying their facial features and/or voice patterns. Conventional authentication systems lack reliable methods for detecting deepfake attempts because they rely on first-order information, such as passwords, authentication tokens, or a single instance of voice recognition or facial recognition. This information may be more susceptible to misuse of deepfake technology and/or may present a single point of failure for the authentication system. Thus, there exists a need for an effective and reliable system for deepfake detection in systems such as those managed by an enterprise organization.

### SUMMARY

Aspects of the disclosure provide effective, efficient, scalable, and convenient technical solutions that address and overcome the technical problems associated with current methods of deepfake detection. In accordance with one or more arrangements of the disclosure, a computing platform with at least one processor, a communication interface, and memory storing computer-readable instructions may train a detection model to perform micromodeling based on input of sample information. The computing platform may train the detection model based on historical sample information. The computing platform may receive, from a user device, sample information for identification of a user. The computing platform may generate, based on the sample information and by performing micromodeling using the detection model, micromodeling information. The computing micromodeling information may include a plurality of clusters of sample information associated with the user. The computing platform may train, based on the micromodeling information, the detection model to output similarity scores based on input of authentication information for event processing requests. The computing platform may receive, from the user device, an event processing request. The computing platform may generate, based on the event processing request and using the detection model, a similarity score. The similarity score may indicate a similarity between authentication information of the event processing request and the micromodeling information. The computing platform may identify whether the similarity score satisfies a first threshold score by comparing the similarity score to the first threshold score. The computing platform may, based on identifying that the similarity score does not satisfy the first threshold score, cause display of a detection alert indicating a potential cyberthreat. The computing platform may, based on identifying that the similarity score does satisfy the first threshold score, indicate approval of the event processing request. The computing platform may send, based on identifying whether the similarity score satisfies the first threshold score, a response to the event processing request. The computing platform may update, based on sending the response to the event processing request, the detection model.

In one or more arrangements, the computing platform may train, based on the micromodeling information, the detection model to output reliability scores based on input of authentication information for event processing requests. The computing platform may generate, based on the event processing request and using the detection model, a reliability score for at least one cluster of the plurality of clusters. The computing platform may identify whether the reliability score satisfies a second threshold score by comparing the reliability score to the second threshold score. The computing platform may, based on identifying that the reliability score does not satisfy the first threshold score, output a request for new sample information. The computing platform may generate the similarity score further based on identifying that the reliability score does satisfy the first threshold score.

In one or more examples, the computing platform may cause display, at the user device, of a user interface comprising the request for new sample information. The computing platform may receive, from the user device, the new sample information. The computing platform may update, based on the new sample information, the detection model. In one or more arrangements, the computing platform may train the detection model to perform micromodeling by: identifying, based on the historical sample information, a plurality of categories of scored user information and training, based on the plurality of categories of scored user information, the detection model to cluster sample information. Training the detection model to cluster sample information may include training the detection model to assign weights for clusters of sample information corresponding to different categories, of the plurality of categories, of scored user information.

In one or more arrangements, the historical sample information may include voice recognition information and/or facial recognition information. In one or more examples, the computing platform may receive, from the user device, an authentication request. The computing platform may send, to the user device, authentication information for authentication confirmation of the computing platform. The authentication information may include a zero-knowledge authentication parameter. In one or more arrangements, the authentication request may include one or more of: a virtual reality interaction request, a neural link request, and/or a video conference request.

In one or more examples, the sample information may include geolocation information. In one or more arrangements, the sample information may include facial recognition information. In one or more examples, the sample information may include voice recognition information. In one or more arrangements, the computing platform may store the sample information in a user profile in a database. The computing platform may perform micromodeling by accessing, in the database, the sample information. The computing platform may update, based on the micromodeling information, the user profile. The computing platform may update, based on the user profile, the detection model.

In one or more examples, the computing platform may perform the micromodeling by identifying, based on the sample information, a plurality of categories of sample information; assigning, based on the plurality of categories, one or more weights to portions of the sample information; and generating, based on the plurality of categories and the assigned one or more weights, the plurality of clusters of sample information. In one or more arrangements, the plurality of clusters of sample information may include one or more of a cluster of geolocation information, a cluster of facial expressions, and/or a cluster of vocal traits.

In one or more examples, the computing platform may receive, based on causing display of the detection alert, at least one instruction for requesting supplementary authentication. The computing platform may cause display of a user interface for receiving supplementary authentication at the user device. The computing platform may display, on the user interface, a request for the user to perform an action. The computing platform may receive, based on displaying the request for the user to perform the action, an authentication result. The response to the event processing request may be based on the authentication result.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for deepfake detection using micromodeling in accordance with one or more example arrangements;

FIGS. 2A-2F depict an illustrative event sequence for deepfake detection using micromodeling in accordance with one or more example arrangements;

FIGS. 3A-3C depict illustrative graphical user interfaces generated as part of deepfake detection using micromodeling in accordance with one or more example arrangements; and

FIGS. 4A-4B depict an illustrative method for deepfake detection using micromodeling in accordance with one or more example arrangements.

### DETAILED DESCRIPTION

In the following description of various illustrative arrangements, reference is made to the accompanying drawings, which form a part hereof, and in which is shown, by way of illustration, various arrangements in which aspects of the disclosure may be practiced. In some instances, other arrangements may be utilized, and structural and functional modifications may be made, without departing from the scope of the present disclosure. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

It is noted that various connections between elements are discussed in the following description. It is noted that these connections are general and, unless specified otherwise, may be direct or indirect, wired or wireless, and that the specification is not intended to be limiting in this respect.

Aspects described herein are related to deepfake detection using micromodeling. In some instances, entities such as an enterprise organization (e.g., a financial institution, and/or other institutions) may utilize one or more authentication systems configured to protect a network and/or control access to information managed by, for example, the enterprise organization. Some such systems rely on methods of authenticating a user based on facial features and/or voice patterns. However, an increasing number of technologies, known as deepfake technologies, are available that allow a threat actor to impersonate a user by copying their facial features and/or voice patterns. These deepfake technologies may allow threat actors to gain unauthorized access to private information and/or networks. Conventional authentication systems lack reliable methods of detecting deepfake attempts. For example, in a metaverse environment, a user may be associated with a virtual avatar that limits options for authentication to, for example, authentication based on features such as voice recognition, or actions that might be performed using the avatar. These and other types of authentication may be susceptible to misuse of deepfake technology. Thus, there exists a need for an effective and reliable system for deepfake detection in systems such as those managed by an enterprise organization.

Accordingly, in some instances, entities such as an enterprise organization (e.g., a financial institution, and/or other organizations/institutions) may deploy, maintain, and/or otherwise utilize a detection platform leveraging micromodeling techniques to provide improvements to the accuracy and reliability of deepfake detection systems. The use of micromodeling offers improvements over conventional authentication systems because it utilizes machine learning to identify elements of recognized facial features and/or recognized voice patterns that cannot be impersonated by deepfake technologies. In doing so, the detection platform as described herein provides an increased level of reliability in deepfake detection. For example, a conventional authentication system may have a user send a one-time token, passcode, or the like to confirm their identity if the system suspects deepfake technology may be in use to impersonate the user. Such methods are susceptible to threat actors who might intercept or access the one time token, passcode, or the like. The detection platform as described herein may utilize second order information beyond simple tokens, passcodes, or the like.

A detection platform as described herein may use micromodeling to combine a number of different authentication techniques (e.g., facial recognition, voice pattern recognition such as recognition of accent, emphasis, vocabulary, or the like, biometric keys (e.g., fingerprint recognition, or the like), and/or other techniques) by generating micromodeling information. The micromodeling information may include scored or weighted clusters of information sampled from a user (e.g., biometric information, facial recognition information, voice recognition information, or the like). The scored or weighted clusters of information may be based on different categories (e.g., geolocation, vocal traits such as pitch, intonation, or the like, facial expressions, or the like), so that the micromodeling information may be used to provide more accurate authentication of a user than systems utilizing unclustered, or first-order, information.

In some examples, the micromodeling information may be stored in a profile. The profile and/or the sample information may be used to train a machine learning model to apply the micromodeling information to authentication information gathered when a user attempts to authenticate with the system utilizing the detection platform. For example, a system utilizing the detection platform may prompt a user to perform some action (e.g., perform a gesture, speak a phrase or term, and/or other actions). For instance, the user may be accessing the system via a virtual reality environment or a neural link device and the user may be prompted to speak a certain phrase. The detection platform may use the machine learning model (e.g., a detection model) to compare information of the action to the profile of the user to identify a likelihood of deepfake technology being used to impersonate the user (e.g., based on a similarity score generated by the detection model, or the like). If the likelihood exceeds a certain threshold, an administrator, security center, or the like may be notified and a remediation action (e.g., denying access to requested information, blocking an event processing request, requesting supplementary authentication, or the like) to prevent the threat actor impersonating the user from accessing private information or networks may be executed.

By performing the functions described above, the detection platform described herein may provide a number of benefits over conventional systems. By implementing a detection model that employs second-order biometric information to identify deepfakes, the detection platform may improve security of a network and improve reliability of an authentication system to a greater degree than conventional systems utilizing first-order information such as an authentication token. Additionally, the detection platform may provide improvements to the effectiveness of deepfake detection technologies by training and dynamically updating a detection model comprising machine learning algorithms in real time. The use of such a model together with dynamically updated profiles for users may provide for improved training of the micromodeling model, increasing the likelihood of the micromodeling model accurately identifying deepfakes before a threat actor gains access to a network.

In some examples, in performing the methods of deploying and/or utilizing the detection platform as described herein, the detection platform may train one or more machine learning models. For example, the detection platform may train the detection model as described herein based on historical sample information, such as voice recognition information and/or facial recognition information, previously gathered by the detection platform and/or associated devices. Training the detection model may cause the detection model to output reliability scores indicating a reliability of micromodeling information being used by the detection platform. Training the detection model may cause the detection model to output the similarity scores used to identify potential threat actors/cyberthreats, as described herein. The detection platform may utilize similarity scores generated by the detection model to output deepfake detection alerts.

These and various other aspects will be discussed more fully herein.

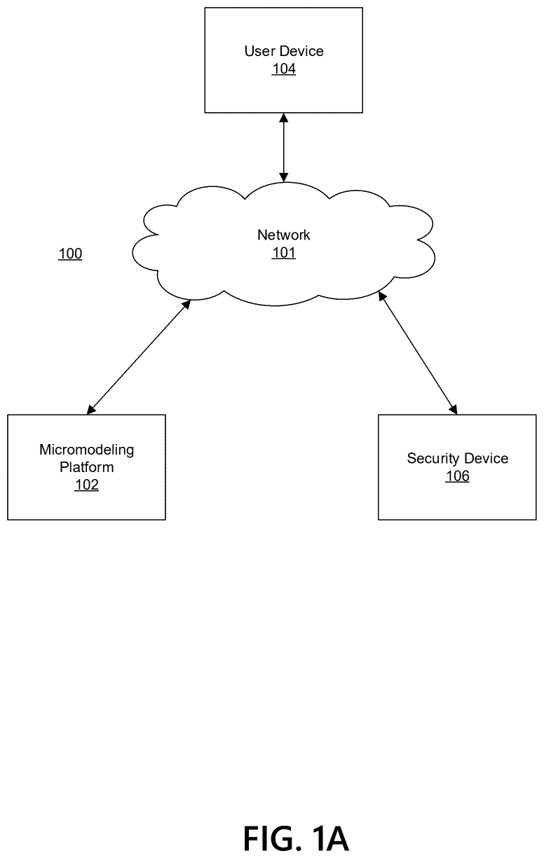

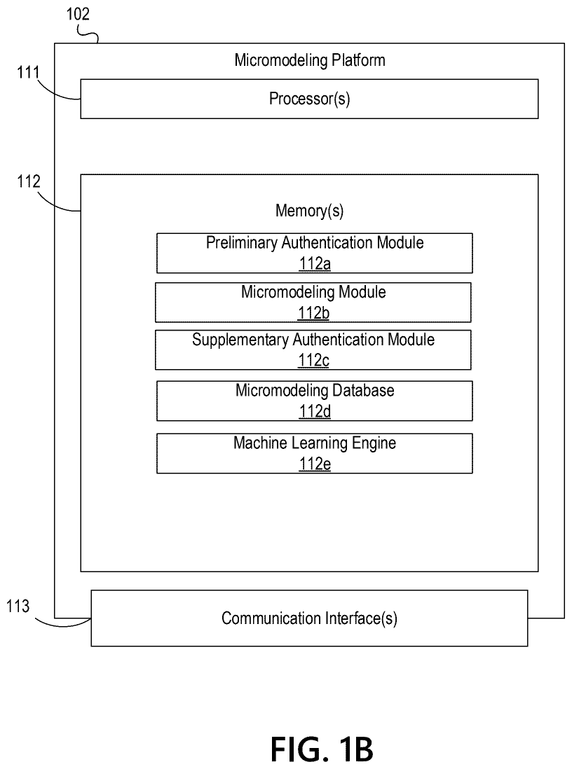

FIGS. 1A-1B depict an illustrative computing environment for deepfake detection using micromodeling in accordance with one or more example arrangements. Referring to FIG. 1A, computing environment 100 may include one or more computer systems. For example, computing environment 100 may include a micromodeling platform 102, a user device 104, a security device 106, and/or other computer systems.

As described further below, micromodeling platform 102 may be a computer system that includes one or more computing devices (e.g., servers, laptop computer, desktop computer, mobile device, tablet, smartphone, and/or other devices) and/or other computer components (e.g., processors, memories, communication interfaces) that may be used to configure, train, and/or execute one or more machine learning models (e.g., a detection model, such as a model configured to detect deepfake attempts, and/or other models). For example, the micromodeling platform 102 may train a detection model to perform micromodeling based on input of sample information, output similarity scores and/or reliability scores based on input of authentication information, and/or perform other functions described herein. The micromodeling platform 102 may be managed by and/or otherwise associated with an enterprise organization (e.g., a financial institution, and/or other institutions) that may, e.g., be associated with one or more additional systems (e.g., user device 104, security device 106, and/or other systems). In one or more instances, the micromodeling platform 102 may be configured to communicate with one or more systems (e.g., user device 104, security device 106, and/or other systems) to perform an information transfer, train machine learning models, generate micromodeling information, generate similarity scores and reliability scores, cause display of detection alerts, and/or perform other functions. In one or more examples, the micromodeling platform 102 may host, generate, and/or otherwise control a virtual reality environment.

The user device 104 may be a computing device (e.g., laptop computer, desktop computer, mobile device, tablet, smartphone, neural link device, virtual reality access device, server, server blade, and/or other device) and/or other data storing or computing component (e.g., processors, memories, communication interfaces, databases) that may be used to transfer information between devices (e.g., authentication information, event processing requests, sample information, and/or other information) and/or perform other functions. In some examples, the user device 104 may be a device or system configured to allow a user to interact with a virtual or artificial reality environment. For example, the user device 104 may be a virtual reality headset paired with one or more virtual reality manipulation components/devices. In some examples, the user device 104 may be a neural link device configured to allow a user to control another computing device (e.g., a laptop computer, desktop computer, mobile device, tablet, smartphone, and/or other device). In some examples, the user device 104 may be associated with a particular user (e.g., a customer of the enterprise organization). In some instances, the user device 104 may be configured to display one or more graphical user interfaces (e.g., sampling interfaces, supplementary authentication interfaces, and/or other interfaces).

The security device 106 may be a computing device (e.g., laptop computer, desktop computer, mobile device, tablet, smartphone, server, server blade, and/or other device), system of devices, and/or other data storing or computing component (e.g., processors, memories, communication interfaces, databases) that may be used to transfer information (e.g., detection alerts, instructions for supplementary authentication, and/or other information) between devices and/or perform other functions. In some examples, the security device 106 may be associated with a particular entity and/or organization (e.g., financial institutions, and/or other entities/organizations). In some instances, the security device 106 may be configured to communicate with one or more systems (e.g., micromodeling platform 102, user device 104, and/or other systems) as part of causing supplementary authentication, and/or performing other functions. In some instances, the security device 106 may include, and/or correspond to, a security operations center (SOC) and/or other security systems or services.

Computing environment 100 also may include one or more networks, which may interconnect micromodeling platform 102, user device 104, and security device 106. For example, computing environment 100 may include a network 101 (which may interconnect, e.g., micromodeling platform 102, user device 104, and security device 106).

In one or more arrangements, micromodeling platform 102, user device 104, and security device 106, may be any type of computing device capable of sending and/or receiving requests and processing the requests accordingly. For example, micromodeling platform 102, user device 104, security device 106, and/or the other systems included in computing environment 100 may, in some instances, be and/or include server computers, desktop computers, laptop computers, tablet computers, or the like that may include one or more processors, memories, communication interfaces, storage devices, and/or other components. As noted above, and as illustrated in greater detail below, any and/or all of micromodeling platform 102, user device 104, and security device 106 may, in some instances, be special-purpose computing devices configured to perform specific functions.

Referring to FIG. 1B, micromodeling platform 102 may include one or more processors 111, memory 112, and communication interface 113. A data bus may interconnect processors 111, memory 112, and communication interface 113. Communication interface 113 may be a network interface configured to support communication between micromodeling platform 102 and one or more networks (e.g., network 101, or the like). Communication interface 113 may be communicatively coupled to the processors 111. Memory 112 may include one or more program modules having instructions that, when executed by processors 111, cause micromodeling platform 102 to perform one or more functions described herein, and/or one or more databases (e.g., a micromodeling database 112d, or the like) that may store and/or otherwise maintain information which may be used by such program modules and/or processors 111. In some instances, the one or more program modules and/or databases may be stored by and/or maintained in different memory units of micromodeling platform 102 and/or by different computing devices that may form and/or otherwise make up micromodeling platform 102. For example, memory 112 may have, host, store, and/or include a preliminary authentication module 112a, a micromodeling module 112b, a supplementary authentication module 112c, a micromodeling database 112d, a machine learning engine 112e, and/or other modules and/or databases.

Preliminary authentication module 112a may have instructions that direct and/or cause micromodeling platform 102 to perform preliminary authentication of a user device (e.g., user device 104, or the like). For example, preliminary authentication module 112a may have instructions that direct and/or cause the micromodeling platform 102 to receive sample information for identification of a user, receive authentication requests, send authentication confirmation information, cause display of a user interface, and/or perform other functions. Micromodeling module 112b may have instructions that direct and/or cause micromodeling platform 102 to generate micromodeling information, receive event processing requests, generate reliability scores, use a detection model, and/or perform other functions. Supplementary authentication module 112c may have instructions that direct and/or cause the micromodeling platform 102 to generate similarity scores, cause display of detection alerts, cause display of user interfaces, send responses to event processing requests, update detection models, request supplementary authentication information, and/or perform other functions. Micromodeling database 112d may have instructions causing micromodeling platform 102 to store (e.g., in memory 112) correlations and/or information used to train machine learning models, profiles of micromodeling information, and/or other information. Machine learning engine 112e may have instructions to train, implement, and/or update one or more machine learning models, such as a detection model, and/or other machine learning models. Although preliminary authentication module 112a, micromodeling module 112b, supplementary authentication module 112c, micromodeling database 112d, and machine learning engine 112e are depicted as separate modules herein, the instructions stored by these modules may be stored in any number of modules without departing from the scope of this disclosure.

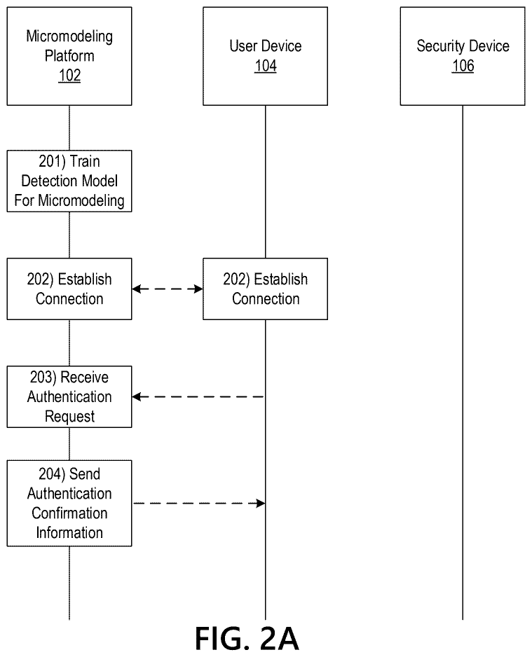

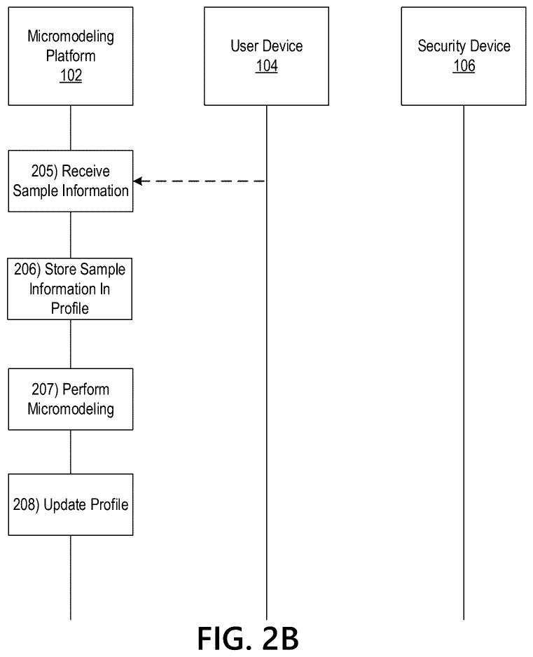

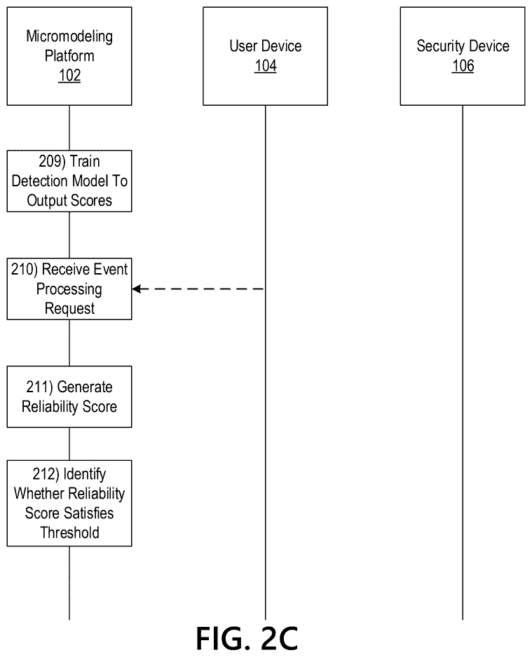

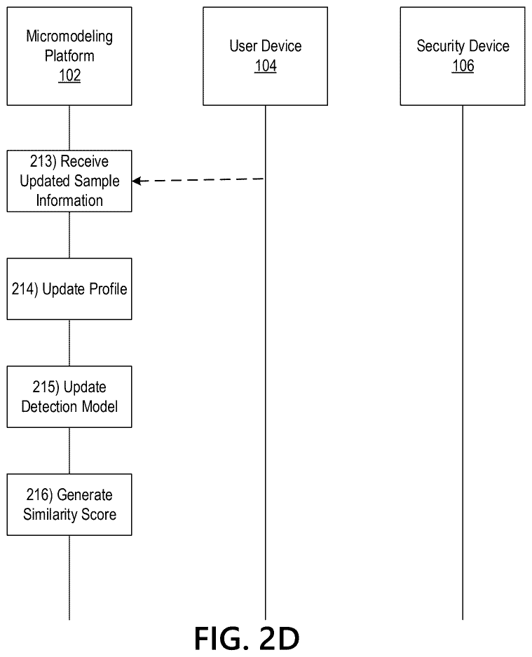

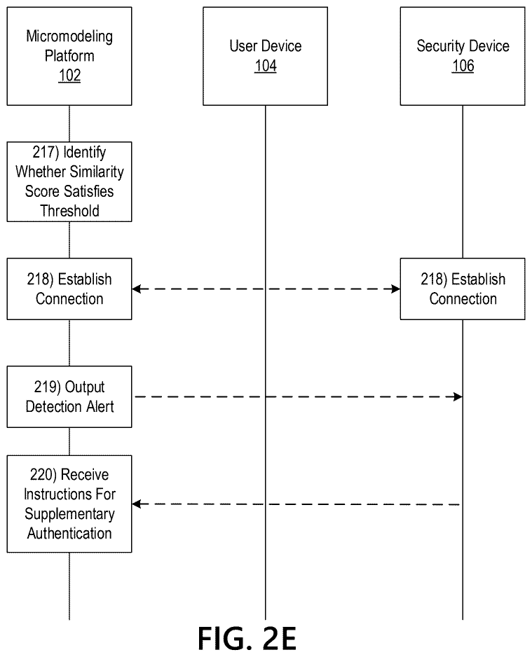

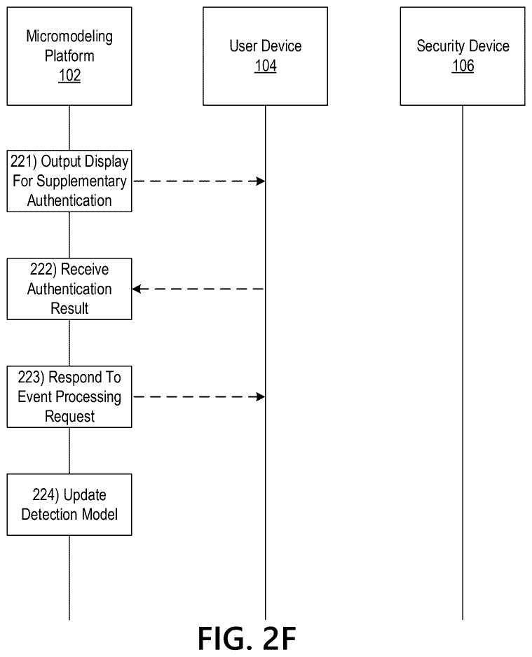

FIGS. 2A-2F depict an illustrative event sequence for deepfake detection using micromodeling in accordance with one or more example arrangements. Referring to FIG. 2A, at step 201, the micromodeling platform 102 may train and/or otherwise configure a detection model. For example, the micromodeling platform 102 may train and/or otherwise configure, using the machine learning engine 112e and based on historical sample information, the detection model to perform micromodeling based on input of sample information. The micromodeling platform 102 may train and/or otherwise configure the detection model by providing the historical sample information as input. For example, the historical sample information may be and/or include voice recognition information (e.g., vocal patterns, pitch, intonation, pronunciation, accents, or the like) and/or additional physical recognition information, such as facial recognition information (e.g., eye color, expressions, or the like) of one or more users. The historical information may further include scored categories of the underlying voice recognition information and/or other physical recognition information. For example, the historical sample information may include samples of a facial expression, such as a smile, from a number of users, the samples of the facial expression being grouped into scored categories based on reliability of the information. Samples of the facial expression gathered more than one month prior to the micromodeling platform 102 training the detection model may, for example, be grouped into a category with a lower score than samples of the facial expression gathered within the previous month. The historical sample information may be information gathered from users, with the consent of the users, when accessing systems of the enterprise organization associated with the micromodeling platform 102 (e.g., via the user device 104, and/or similar devices). Also or alternatively, the historical sample information may be information submitted by the users when registering an account, profile, or the like with the micromodeling platform 102.

In some instances, to configure and/or otherwise train the detection model, the micromodeling platform 102 may cause the detection model to process the historical sample information using one or more machine learning techniques. For example, the micromodeling platform 102 may cause the detection model to process the historical sample information by applying natural language processing, natural language understanding, supervised machine learning techniques (e.g., regression, classification, neural networks, support vector machines, random forest models, naïve Bayesian models, and/or other supervised techniques), unsupervised machine learning techniques (e.g., principal component analysis, hierarchical clustering, K-means clustering, and/or other unsupervised techniques), and/or other techniques.

In some examples, in training and/or otherwise training the detection model to perform micromodeling, the micromodeling platform 102 may cause the detection model to store one or more correlations based on the historical sample information and/or otherwise learn from the historical sample information. By causing the detection model to store the one or more correlations or otherwise learn from the historical sample information, the micromodeling platform 102 may train the detection model to perform micromodeling by combining different biometric variations (e.g., changes in facial expression, accents, emphasis, intonation, pronunciation, vocabular, or the like), in different samples of the voice and/or face of a user (i.e., sample information), into categories. For example, the micromodeling platform 102 may cause the detection model to identify multiple categories of scored user information in the historical sample information and store correlations between portions of the historical sample information and the corresponding scored categories. If, for example, the historical sample information includes voice pattern information grouped into different categories based on when the voice pattern information was gathered, the micromodeling platform 102 may cause the detection model to store correlations between the time period that the voice pattern information was gathered and the score for each category.

By causing the detection model to identify the plurality of categories of scored historical sample information, the micromodeling platform 102 may train and/or otherwise configure the detection model to cluster sample information when it is received by the detection model. For example, the micromodeling platform 102 may train and/or otherwise configure the detection model to generate, store, and/or otherwise produce initial classifications, clusters, or the like, of sample information based on the stored correlations to the categories of scored historical sample information. The micromodeling platform 102 may further train the detection model to assign weights for different categories of sample information. The weights may then be attributed to clusters of sample information generated by the detection model. For example, based on the training described above, the micromodeling platform 102 may configure the detection model to cluster sample information based on categories such as recency (i.e., when the sample information was gathered), type (e.g., facial recognition information, vocal recognition information, or the like), and/or other categories. The micromodeling platform 102 may train and/or otherwise configure the detection model to assign weights to these clusters based on the categories. The weights may be integers, decimal values, grades, or other indicators of the reliability of sample information in the cluster for use in deepfake detection. For example, the detection model may process the one or more stored correlations to identify that a cluster of voice information including pitch and cadence information for users should be assigned a weight that exceeds the weight assigned to a cluster of voice information including only accent information (e.g., because accent information may be more likely to change over time). As another example, the detection model may process the one or more stored correlations to identify that a cluster of sample information gathered from a user within the previous week should be assigned a weight that exceeds the weight assigned to a cluster of sample information gathered from a user within the previous month. The micromodeling platform 102 may train and/or otherwise configure the detection model to perform micromodeling by processing, clustering, and assigning weights to sample information, as described herein, to produce micromodeling information that comprises weighted clusters of sample information associated with specific users.

At step 202, the micromodeling platform 102 may establish a connection with the user device 104. For example, the micromodeling platform 102 may establish a first wireless data connection with the user device 104 to link the user device 104 with the micromodeling platform 102 (e.g., in preparation for receiving sample information, receiving authentication requests, sending authentication confirmation information, and/or to perform other functions). In some instances, the micromodeling platform 102 may identify whether or not a connection is already established with the user device 104. If a connection is already established with the user device 104, the micromodeling platform 102 might not re-establish the connection. If a connection is not yet established with the user device 104, the micromodeling platform 102 may establish the first wireless data connection as described herein.

At step 203, the micromodeling platform 102 may receive an authentication request. For example, the micromodeling platform 102 may receive an authentication request from the user device 104 and via the communication interface 113 while the first wireless data connection is established. The authentication request may be and/or include a virtual reality interaction request (e.g., a request to access a virtual reality environment, a request to access information of the micromodeling platform 102 in a virtual reality environment, or the like). The authentication request may additionally or alternatively include a neural link request, a video conference request, and/or any other request to authenticate the user in order to allow the user to access the micromodeling platform 102 and/or devices associated with the micromodeling platform 102 via the user device 104. In some examples, the authentication request may include, or be accompanied by, sample information of the user associated with the user device 104. For example, the authentication request may include a voice recording, digital photograph, facial capture, and/or other sample information that may be used for facial recognition and/or vocal recognition. In some examples, the micromodeling platform 102 might not receive any sample information until the micromodeling platform 102 authenticates itself to the user device 104 (e.g., to improve security by ensuring biometric information of the user is not sent until the user can confirm the micromodeling platform 102 is authorized to receive such information). In these examples, the authentication request may comprise first-order authentication information such as a password, encryption key, or the like and the micromodeling platform 102 may receive the sample information at a later time (e.g., as described at steps 204-205 herein).

At step 204, the micromodeling platform 102 may send authentication confirmation information. For example, the user device 104 may send authentication confirmation information to the user device 104 to perform dual authentication to confirm that the user device 104 is authorized to access information in the micromodeling platform 102 and that the micromodeling platform 102 is authorized to receive sample information of the user of the user device 104. Performing dual authentication improves security and improves the user experience by ensuring the user of the user device 104 can trust the micromodeling platform 102 before the user sends any sample information that might be used to impersonate the user (e.g., via a deepfake) if the user mistakenly sends the sample information to an entity other than the entity associated with the micromodeling platform 102. This also reduces the likelihood of phishing attacks, as users interacting with micromodeling platform 102 may wait until authentication confirmation information is received before sending sample information. The authentication confirmation information may be and/or include a zero-knowledge authentication parameter. For example, the authentication confirmation information may include a parameter, value, or the like indicating that the micromodeling platform 102 recognized a value without conveying any information about the value itself. The recognized value may be the authentication information included in the authentication request. For example, if the authentication information included a password, the micromodeling platform 102 may provide, as authentication confirmation information, a parameter (e.g., a confirmation code, a message, or the like) indicating that the micromodeling platform 102 recognized the password and that the password is associated with, for example, an account of the user, without returning any information that could identify the password. In this way, the security of the password is preserved, but the user of the user device 104 is able to authenticate the micromodeling platform 102 (e.g., by confirming the micromodeling platform 102 recognized the password).

In some examples, the authentication confirmation information may also or alternatively include one or more messages or instructions directing the user device 104 to display a user interface. For example, the authentication confirmation information may be and/or include instructions directing the user device 104 to display a user interface for gathering sample information from the user. In some examples, the display of the user interface may authenticate the micromodeling platform 102 to the user device 104. For example, causing display of the user interface may be a zero-knowledge parameter that confirms, to the user, that the micromodeling platform 102 recognized the authentication information included in the authentication request. In some examples, the display of the user interface may supplement other authentication confirmation information sent by the micromodeling platform 102 as described above.

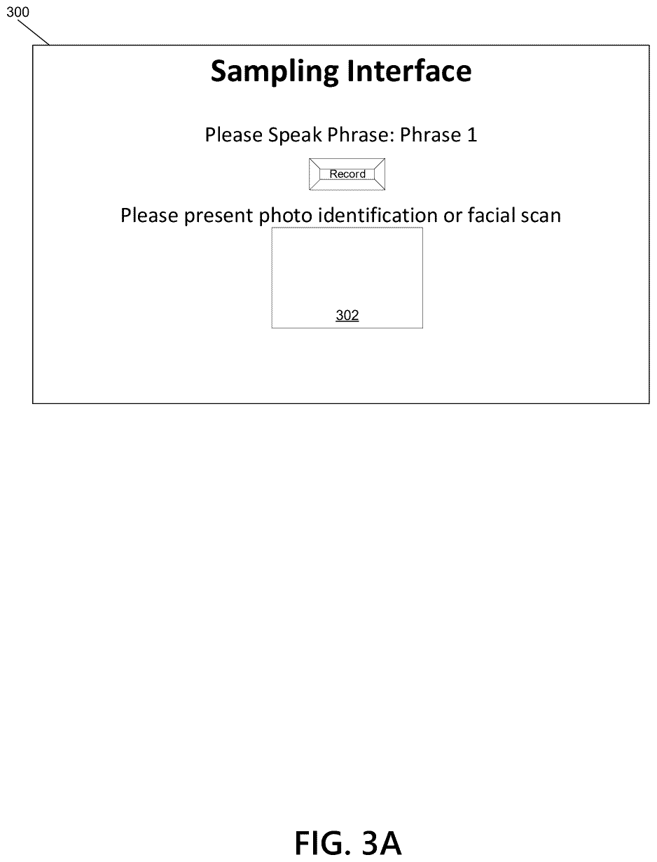

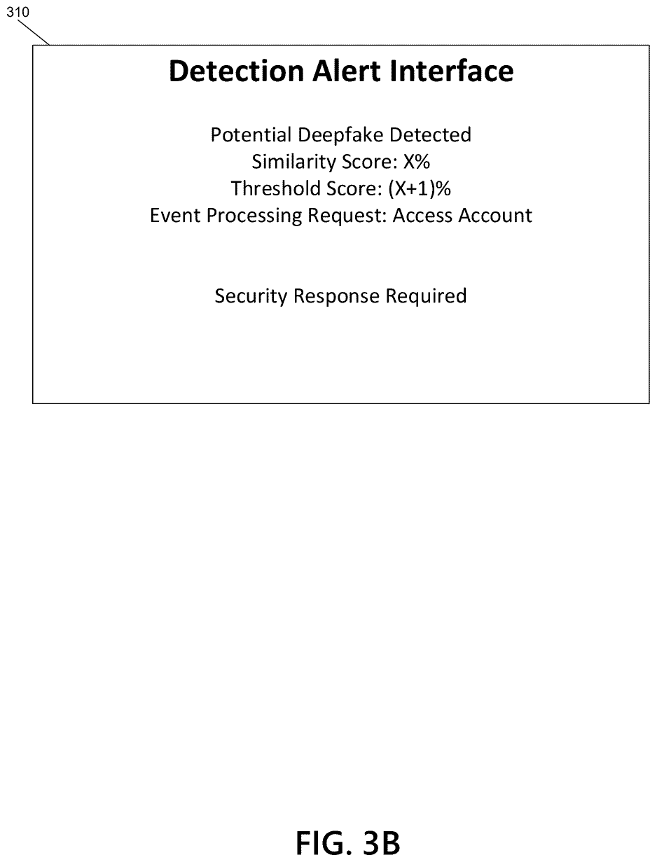

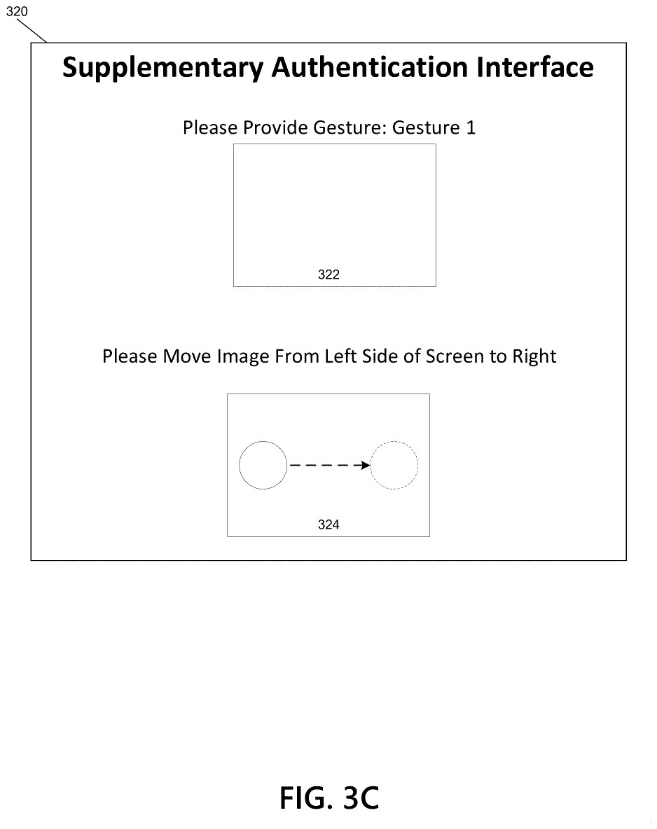

In causing display of the user interface, the micromodeling platform 102 may cause display of a graphical user interface similar to sampling interface 300, which is illustrated in FIG. 3A. For example, the micromodeling platform 102 may output, with or as the authentication confirmation information, one or more instructions (via the communication interface 113 and while the first wireless data connection is established) to the user device 104, causing the user device 104 to display the sampling interface 300.

Referring to FIG. 3A, in some instances, the sampling interface 300 may include information requesting the user of the user device 104 to provide sampling information. For example, the sampling interface 300 may include information such as a request for voice recognition information (e.g., a request a recording of the voice of the user that may be used for voice recognition), a request for facial recognition information (e.g., a request for an identification card including the face of the user, a request to capture an image of the user via a camera included in the user device 104, a request for the user to make a particular facial expression, and/or other requests for information that may be used for facial recognition), a request for additional biometric information (e.g., a request for a fingerprint, if the user device 104 is configured to provide such additional biometric information) and/or other information. The sampling interface 300 may also display interface elements or selectable options requesting user input. For example, the sampling interface 300 may display one or more of: an information entry field, a button or buttons, toggle or toggles, check box or boxes, a window mirroring a view of the camera of the user device 104, and/or other interface elements. For example, as illustrated in FIG. 3A, the interface elements may be one or more buttons the user might toggle or select to initiate a recording to capture voice information. Also or alternatively, the interface elements may be a window 302 mirroring a view of the camera of the user device 104 that the user might use to present a face for a facial scan or a photo identification card. In some instances, the user may be prompted to input user feedback (e.g., to speak a phrase, present identification, present the face of the user, and/or otherwise input the feedback). In these examples, the user device 104 may provide the feedback to the micromodeling platform 102 and the micromodeling platform 102 may receive the user input/feedback (e.g., as sample information, as described herein with respect to step 205).

Referring to FIG. 2B, at step 205, the micromodeling platform 102 may receive sample information. For example, the micromodeling platform 102 may receive the sample information from the user device 104 via the communication interface 113 and while the first wireless data connection is established. In some examples, the micromodeling platform 102 may receive the sample information based on user feedback provided at a user interface, such as sampling interface 300. The sample information may be information used to identify users attempting to access the micromodeling platform 102 and/or other devices associated with the micromodeling platform 102. The sample information may be and/or include biometric information, such as facial recognition information, voice recognition information, and/or other biometric information. Voice recognition information may be and/or include a voice recording of the user speaking a particular word or phrase, and/or other means of identifying vocal traits of a user such as pitch, cadence, pronunciation, intonation, or the like. Facial recognition information may be and/or include a digital capture of the face of a user and may comprise an iris scan, a retina scan, facial geometry, and/or other information used for recognizing a user. Additionally or alternatively, in some examples, the sample information may be and/or include supplementary information for identifying a user and/or for determining a reliability of the facial recognition information or the voice recognition information. For example, the sample information may include geolocation information indicating a geographic location of the user device 104, and/or other information.

At step 206, the micromodeling platform 102 may store the sample information in a profile. For example, the micromodeling platform 102 may maintain data structures comprising profiles of users associated with the micromodeling platform 102 in a database such as micromodeling database 112d. The profiles may include sample information captured from the user at various occasions. The profiles may additionally or alternatively include micromodeling information generated by the detection model, as described further herein. In some examples, the profiles may be associated with other profiles in a particular group. For example, a given profile may be associated with a group of other profiles corresponding to the same geographic region, the same temporal period (e.g., a number of years the users associated with the profiles have been customers of the enterprise organization), and/or other categories or traits. In storing the sample information, the micromodeling platform 102 may store the sample information in a profile associated with the user of the user device 104. If no profile exists for the user of the user device 104, the micromodeling platform 102 may generate a new profile for storing the sample information.

At step 207, the micromodeling platform 102 may perform micromodeling. For example, the micromodeling platform 102 may perform micromodeling by inputting the sample information into the detection model to generate micromodeling information. To perform micromodeling, the micromodeling platform 102 may retrieve the sample information from the profile described at step 206 by accessing the database (e.g., micromodeling database 112d).

In performing the micromodeling, the micromodeling platform 102 may cause the detection model to identify, based on the sample information, categories of the sample information. In some examples, the detection model may use the results of training the detection model as described herein to identify the categories of sample information. For example, the micromodeling platform 102 may have previously trained the detection model, based on historical sample information (e.g., including sample information previously gathered from a number of users), to store correlations between categories of sample information. The detection model may use the stored correlation to identify the categories of the sample information received at step 205. For example, based on stored correlations indicating historical sample information was categorized based on factors such as type (e.g., voice recognition information, facial recognition information, geolocation information, and/or other types of sample information), recency (e.g., the time of day at which the sample information was captured or received, an amount of time that has passed after the sample information was captured or received, or the like), and/or other parameters, the micromodeling platform 102 may cause the detection model to identify the categories of the sample information by matching sample information to the categories indicated by the stored correlations. As an example, based on sample information including a video clip of a user speaking a phrase, the micromodeling platform 102 may cause the detection model to identify facial recognition information and voice recognition information in the sample information and categorize the sample information accordingly. In some examples, in identifying the categories of the sample information, the detection model may identify smaller categories, or subcategories, of sample information after identification of initial categories. For example, based on identifying facial recognition information, the micromodeling platform 102 may cause the detection model to identify different categories of facial recognition information, such as representations of expressions (e.g., smiling, raising an eyebrow, frowning), iris scans, retina scans, facial geometry, and/or other categories of facial recognition information.

In performing the micromodeling, the micromodeling platform 102 may also cause the detection model to assign one or more weights to portions of the sample information based on the identified categories. For example, the detection model may assign weights to categories of sample information based on stored correlations created during training of the detection model. The weights may be integers, decimal values, grades, or other indicators of the reliability of sample information for use in deepfake detection. In some examples, the weights may be assigned to sample information categorized based on type. For example, a facial expression category may be assigned a weight that exceeds a weight of sample information in an accent category (e.g., because accents may be subject to change more commonly than the manner in which a user makes a particular facial expression). The detection model may assign a weight to each category of sample information identified by the detection model. In these examples, portions of the sample information may be assigned to multiple different categories and may be associated with different weights. For example, voice recognition information captured within the previous week may receive a first weight assigned to the voice recognition information category and a second weight assigned to the category of information received within the previous week.

The micromodeling platform 102 may complete the micromodeling process by generating the micromodeling information. The micromodeling platform 102 may cause the detection model to generate the micromodeling information by generating, based on the identified categories and the assigned weights, clusters of sample information. In some examples, clusters of sample information may directly correspond to the identified categories. For example, the micromodeling platform 102 may cause the detection model to generate N clusters of sample information, where each of the N clusters corresponds to one of N categories of sample information and is associated with the weight assigned to its respective category. In some examples, clusters of sample information may correspond to multiple identified categories. For example, the detection model may generate a cluster of sample information comprising frames of a video of a user speaking a phrase. The cluster of sample information may correspond to both a facial recognition information category and a voice recognition information category. In these examples, the detection model may assign a weight to the cluster of sample information based on the weights assigned to each category included in the cluster. For example, a cluster comprising sample information from two categories may be assigned a weight equivalent to the sum of the weights of each category. It should be understood that in other examples, other algorithms or formulas may be used to calculate the weight for a cluster without departing from the scope of this disclosure. As a result of performing the micromodeling, the micromodeling platform 102 may produce micromodeling information including clusters of sample information (e.g., clusters of geolocation information, clusters of facial expressions, clusters of vocal traits, and/or other clusters of sample information) associated with different weights.

At step 208, based on performing micromodeling, the micromodeling platform 102 may update a profile. For example, the micromodeling platform 102 may update the profile associated with the user that provided the sample information. The micromodeling platform 102 may update the profile by storing the micromodeling information, generated by performing micromodeling, to the profile in the micromodeling database 112d.

Referring to FIG. 2C, at step 209, the micromodeling platform 102 may train the detection model to output scores based on input of authentication information for event processing requests. For example, the micromodeling platform 102 may train the detection model to output reliability scores based on input of authentication information (e.g., additional sample information) for an event processing request, such as a request to access the micromodeling platform 102 and/or information managed by the entity associated with the micromodeling platform 102. In training and/or otherwise configuring the detection model, the micromodeling platform 102 may update the detection model based on the user profile and/or the micromodeling information stored in the user profile. For example, in training the detection model to output reliability scores, the micromodeling platform 102 may train the detection model to generate reliability scores for clusters of micromodeling information. The micromodeling platform 102 may train and/or otherwise configure the detection model to generate reliability scores for clusters of micromodeling information based on weights assigned to the clusters. In some examples, the micromodeling platform 102 may train the detection model to generate a reliability score for a cluster of micromodeling information that is equal to the weight assigned to the cluster. For example, the micromodeling platform 102 may train the detection model to generate such a reliability score in response to receiving authentication information for an event processing request. In these examples, the micromodeling platform 102 may train the detection model to use the authentication information to identify clusters of micromodeling information for the user associated with the event processing request and output reliability scores based on the weight of the identified clusters. In some examples, the micromodeling platform 102 may train and/or otherwise configure the detection model to generate and output the reliability scores by using the weight of a cluster of micromodeling information as a variable in an algorithm or formula for generating reliability scores. For example, the micromodeling platform 102 may train the detection model to generate a reliability score for a cluster of micromodeling information representing the sum of the weight of the cluster and a predetermined value associated with a length of time that has passed after the micromodeling information was generated. The predetermined value may be an integer, decimal percentage, or other value.

The micromodeling platform 102 may also train the detection model to output similarity scores based on input of authentication information for event processing requests. The micromodeling platform 102 may train the detection model based on the micromodeling information. The micromodeling platform 102 may train the detection model to generate the similarity scores by identifying changes in the micromodeling information over a period of time. For example, the micromodeling platform 102 may cause the detection model to store one or more correlations, references, or the like representing the micromodeling information at the time it is generated by the detection model. In these examples, the micromodeling platform 102 may, over time, train the detection model to identify and/or predict changes in the micromodeling information associated with a user. For example, based on multiple sets of micromodeling information, generated as described herein over a period of, for example, two or more months, the micromodeling platform 102 may cause the detection model to store correlations indicating differences between the sets of micromodeling information. For example, a first set of micromodeling information may include a first facial geometry, and a second set of micromodeling information may include a second facial geometry with slight differences (e.g., additional lines, changed hair style, or the like). The detection model may be configured to predict, based on the first set and the second set of micromodeling information, a third facial geometry for the user. The micromodeling platform 102 may train and/or otherwise configure the detection model to generate similarity scores by comparing authentication information (e.g., additional sample information) for an event processing request with the micromodeling information for a user and/or with predicted micromodeling information for the user to identify a degree of similarity between the authentication information and the micromodeling information and/or the predicted micromodeling information. The micromodeling platform 102 may train the detection model to recognize that authentication information that produces a lower similarity score indicates a higher likelihood of the source of the event processing request attempting to use deepfake technology to impersonate the user associated with the micromodeling information.

By training the detection model to identify and/or predict changes in the micromodeling information associated with a user, the micromodeling platform 102 provides a number of advantages. For example, because the detection model is trained to predict changes in the micromodeling information associated with a user, the detection model reduces false positives by taking into account potential changes in the face or voice of a user that occur over time. The detection model also improves security by identifying changes that occur over time. For example, if the detection model generates a similarity score, based on comparing the authentication information to micromodeling information that has changed over time, that does not exceed a threshold, the micromodeling platform 102 may request supplementary authentication to confirm the identity of the source of the event processing request. This provides advantages over conventional systems that might accept authentication information that matches outdated facial recognition information or voice recognition information, without comparing the authentication information to multiple sets of micromodeling information.

At step 210, the micromodeling platform 102 may receive an event processing request. For example, the micromodeling platform 102 may receive an event processing request, associated with a user, from the user device 104 and/or while the first wireless data connection is established. The event processing request may be a neural link request, a virtual reality request, and/or other format of request, that requests access to the micromodeling platform 102 and/or information managed by the entity associated with the micromodeling platform 102. For example, the event processing request may be a request to access a user account. In some examples, the event processing request may be associated with the user that sent the initial authentication request (e.g., as described at step 203). The event processing request may include authentication information for use in authenticating the user with the detection platform (e.g., to confirm that no deepfake technology is being used to impersonate the user). In this way, the authentication information for the event processing request may differ from any information associated with the authentication request at step 203, because it may include additional sample information such as facial recognition information, voice recognition information, and/or other sample information that might be provided as input to the detection model. It should be understood that, in some examples, if the same session, communication, or the like during which the micromodeling platform 102 received the sample information at step 205 remains active, the authentication information associated with the event processing request may be the same sample information received at step 205 without departing from the scope of this disclosure.

At step 211, the micromodeling platform 102 may generate reliability scores based on receiving the event processing request. For example, the micromodeling platform 102 may generate reliability scores for each cluster of micromodeling information associated with the user that is associated with the event processing request. In doing so, the micromodeling platform 102 may provide improved accuracy in deepfake detection by ensuring that the micromodeling information that will be used to generate similarity scores and identify potential deepfakes is reliable.

In generating the reliability score, the micromodeling platform 102 may provide the authentication information for the event processing request as input to the detection model. The micromodeling platform 102 may generate reliability scores for clusters of micromodeling information associated with the same user associated with the authentication information. The micromodeling platform 102 may cause the detection model to generate the reliability scores based on weights assigned to the clusters. In some examples, the micromodeling platform 102 may cause the detection model to generate a reliability score for a cluster of micromodeling information that is equal to the weight assigned to the cluster. For example, if the cluster is assigned a weight of 5, out of a possible 10, the micromodeling platform 102 may cause the detection model to generate a reliability score of 5, 0.5, 50%, or other values indicating the weight of the cluster. In some examples, the micromodeling platform 102 cause the detection model generate a reliability score by using the weight of a cluster of micromodeling information as a variable in an algorithm or formula for generating reliability scores. In these examples, the micromodeling platform 102 have previously trained the detection model to use one or more machine learning algorithms to generate the reliability score. For example, the micromodeling platform 102 may have trained the detection model to execute a reliability scoring algorithm using the following constraints/parameters:

$$Reliability Score = CW - ( ( Number of Days Since Cluster Generated ) * n )$$

In this example, CW may represent the cluster weight and n may be a normalization variable selected to convert the number of days since the cluster was generated into a scale equivalent to the scale of the cluster weight. For example, if the cluster weight is a percentage value (e.g., 50%), the normalization variable may be a value selected to convert the number of days since the cluster was generated (e.g., 5 days) into a percentage value based on a predetermined amount by which 5 days passing should impact the cluster weight. For example, the micromodeling platform 102 may be configured to generate a reliability score equivalent to the cluster weight on the first day the cluster is generated, but to decrease the reliability score by 5% for each subsequent day. In this example, using the example reliability scoring algorithm, an initial cluster weight of 50% may cause the detection model to generate a reliability score of 25% (i.e., 50%-5*25%) five days after the cluster is generated.

At step 212, based on generating the reliability score, the micromodeling platform 102 may identify whether the reliability score satisfies a threshold. For example, the micromodeling platform 102 may compare the reliability score to a threshold score to identify whether the reliability score meets or exceeds the threshold score. Based on identifying that the reliability score meets or exceeds the threshold score, the micromodeling platform 102 may proceed to step 216 in FIG. 2D and generate a similarity score without performing the functions recited at step 213-215 in FIG. 2D. Based on identifying that the reliability score does not meet or exceed the threshold score, the micromodeling platform 102 may identify that additional or updated sample information is required from the user to accurately identify potential deepfakes. In these examples, the micromodeling platform 102 may proceed to step 213 in FIG. 2D and receive updated sample information.

Referring to FIG. 2D, at step 213, the micromodeling platform 102 may receive updated sample information from the user device 104. For example, the micromodeling platform 102 may receive new facial recognition information, new geolocation information, new voice recognition information, and/or other updated sample information based on identifying that the reliability score does not meet or exceed the threshold score. In these examples, the micromodeling platform 102 may receive the updated sample information by requesting the updated sample information from the user device 104 and/or by causing display of a user interface. For example, the micromodeling platform 102 may receive the updated sample information by displaying a user interface such as sampling interface 300, as illustrated in FIG. 3A, in the manner described at step 205 herein.

At step 214, based on receiving the updated sample information, the micromodeling platform 102 may update a profile associated with the sample information. For example, the micromodeling platform 102 may update the profile associated with the user that provided the updated sample information. The micromodeling platform 102 may update the profile by storing the updated sample information to the profile in the micromodeling database 112d. The updated sample information may be used, for example, in generating micromodeling information as described herein.

At step 215, based on updating the profile, the micromodeling platform 102 may refine, validate, and/or otherwise update the detection model. For example, the micromodeling platform 102 may update the detection model by providing updated sample information, stored in the profile, as additional training input. The detection model may use unsupervised and/or supervised machine learning techniques to modify its behaviors, algorithms, or the like based on the updated sample information. In some examples, the detection model may additionally or alternatively use the updated sample information to generate additional micromodeling information as described herein. By inputting the updated sample information into the detection model, the micromodeling platform 102 may create and/or update an iterative feedback loop that may continuously and dynamically refine the detection model to improve its generation of micromodeling information. In some instances, updating the detection model may include causing the detection model to update or add one or more stored correlations. For example, the micromodeling platform 102 may cause the detection model to store new correlations and/or update existing correlations such that the detection model may generate micromodeling information, based on the updated sample information, in future iterations of the feedback loop.

In updating the detection model, the micromodeling platform 102 may improve the accuracy of the model for generating similarity scores as well. For example, the updated detection model may utilize updated sample information and/or additional micromodeling information to generate similarity scores based on up-to-date information of the user.

At step 216, the micromodeling platform 102 may generate a similarity score. The similarity score may indicate a similarity between authentication information of the event processing request and the micromodeling information for the user associated with the event processing request. The similarity score may be an integer value, a decimal value, a percentile value, and/or any other value. The micromodeling platform 102 may generate the similarity score based on the event processing request. For example, in generating the similarity score, the micromodeling platform 102 may provide the authentication information of the event processing request to the detection model as input. As described herein, the authentication information may be and/or include voice recognition information, facial recognition information, and/or other sample information provided by the user of the user device 104 to authenticate the event processing request.

Based on inputting the authentication information into the detection model, the micromodeling platform 102 may cause the detection model to perform a comparative analysis of the authentication information against micromodeling information for the user associated with the event processing request. For example, the detection model may use one or more stored correlations to identify micromodeling information for the user and access the micromodeling information in storage (e.g., micromodeling database 112d, and/or other storage). In some examples, the micromodeling platform 102 may generate the similarity score by direct comparison of the authentication information to the micromodeling information. For example, if the authentication information includes a facial scan of the user, the micromodeling platform 102 may generate similarity score indicating a degree of similarity between the facial scan of the user and facial recognition information included in the micromodeling information.

The micromodeling platform 102 may have previously trained the detection model to generate the similarity score by executing one or more algorithms configured to calculate the similarity of the micromodeling information and the authentication information. For example, the detection model may execute an algorithm that subtracts, from a base similarity score of 100%, a predetermined value for each feature of the authentication information that does not match the micromodeling information. Returning to the above example where the authentication information includes a facial scan of the user, the detection model may subtract a value of, for example, 5% from the base similarity score based on identifying that the eye color of the facial scan does not match the eye color of the user in the micromodeling information.

It should be understood that in some examples, the similarity score may be a cumulative score of the similarity between portions of the authentication information and clusters of the micromodeling information. For example, the authentication information may include facial recognition information such as eye color, hair color, and facial geometry, as well as voice recognition information such as pitch, cadence, intonation, or the like. The micromodeling platform 102 may cause the detection model to generate a similarity score by comparing each element of the authentication information to a corresponding element of the micromodeling information. In doing so, the micromodeling platform 102 may cause the detection model to execute one or more machine learning algorithms. For example, the micromodeling platform 102 may have previously trained the detection model to execute a similarity score algorithm using the following constraints/parameters:

$$\frac{( Number of Matched Features )}{( Total Number of Micromodeling Features )} * 100 = Complexity Score .$$

In this example, the detection model may compare particular features/elements of the authentication information against corresponding features/elements in the micromodeling information. The detection model may, based on comparing the features/elements, simultaneously or near-simultaneously execute the example similarity score algorithm to generate a similarity score comprising the quotient of the number of features/elements that match divided by the total number of compared micromodeling features, multiplied by a value of 100. It should be understood that this is merely one illustrative example of a similarity score algorithm that may be executed by the detection model and that additional and/or alternative algorithms may be used without departing from the scope of this disclosure.

Additionally or alternatively, the micromodeling platform 102 may cause the detection model to generate the similarity score by comparing the authentication information with predicted facial recognition information and/or predicted voice recognition information, based on the micromodeling information. For example, as described herein, the detection model may be trained to predict incremental changes in the facial recognition information and/or in the voice recognition information of a user. In these examples, the similarity score may be generated using similar processes and/or algorithms as described above by comparing the authentication information to the predicted information. For example, because facial geometry may shift over time, the detection model may predict a facial geometry of the user at a predetermined period of time (e.g., days, months years, or the like) after the micromodeling information is generated. In generating the similarity score, the micromodeling platform 102 may cause the detection model to compare the authentication information to the predicted facial geometry. By utilizing predictions and accounting for expected changes in sample information over time, the detection model reduces the chance of false positives (i.e., mistakenly identifying a potential deepfake).

Referring to FIG. 2E, at step 217, the micromodeling platform 102 may identify whether the similarity score satisfies a threshold. For example, the micromodeling platform 102 may compare the similarity score to a threshold score selected based on an acceptable level of chance of deepfake attacks. To identify whether the similarity score satisfies the threshold score, the micromodeling platform 102 may identify whether the similarity score meets or exceeds the threshold score. Based on identifying that the similarity score meets or exceeds the threshold score, the micromodeling platform 102 may indicate approval of the event processing request and proceed to step 223 in FIG. 2F without performing the functions recited at steps 218-222. For example, the micromodeling platform 102 may indicate approval of the event processing request by tagging the event processing request for processing, forwarding the event processing request for processing, and/or otherwise indicating that the event processing request should be processed. Based on identifying that the similarity score does not meet or exceed the threshold score, the micromodeling platform 102 may proceed to step 218 and may output a detection alert indicating a potential cyberthreat (e.g., a deepfake attack).

At step 218, the micromodeling platform 102 may establish a connection with the security device 106. For example, the micromodeling platform 102 may establish a second wireless data connection with the security device 106 to link the security device 106 with the micromodeling platform 102 (e.g., in preparation for outputting detection alerts, receiving instructions for supplementary authentication, and/or to perform other functions). In some instances, the micromodeling platform 102 may identify whether or not a connection is already established with the security device 106. If a connection is already established with the security device 106, the micromodeling platform 102 might not re-establish the connection. If a connection is not yet established with the security device 106, the micromodeling platform 102 may establish the second wireless data connection as described herein.

At step 219, the micromodeling platform 102 may output a detection alert to the security device 106. For example, the micromodeling platform 102 may output a message, warning, or the like indicating that the micromodeling platform 102 detected a potential cyberthreat (e.g., a deepfake attack) that requires a response from the security device 106. In some examples, in outputting the detection alert, the micromodeling platform 102 may cause display of a user interface. For example, the micromodeling platform 102 may send, via the communication interface 113 and while the second wireless data connection is established, one or more instructions directing the security device 106 to display the user interface. In causing display of the user interface, the micromodeling platform 102 may cause display of a graphical user interface similar to detection alert interface 310, which is illustrated in FIG. 3B.

Referring to FIG. 3B, in some instances, the detection alert interface 310 may include information notifying the security device 106 that a cyberthreat was detected. For example, the detection alert interface 310 may include information such as an indication that a potential deepfake was detected, an indication of the similarity score generated by the micromodeling platform 102, an indication of the threshold score that was not satisfied by the similarity score, an indication of the pending event processing request, and/or other information. The detection alert interface 310 may also notify the security device 106 that a security response is required to address the cyberthreat (e.g., the potential deepfake attack).

Referring again to FIG. 2E, at step 220, based on outputting the detection alert, the micromodeling platform 102 may receive instructions for supplementary authentication. For example, based on causing display of the detection alert, the micromodeling platform 102 may receive, from the security device 106 and while the second wireless data connection is established, one or more instructions for the micromodeling platform 102 to request supplementary authentication from the user device 104 in order to process the event processing request. The instructions for supplementary authentication may include a request to have the user of the user device 104 move an object across a screen, perform a specific hand gesture, speak a specific phrase, and/or perform other actions that might, for example, indicate the user is not an artificial construct (e.g., a robot, an artificial intelligence, a computer program) attempting to deepfake a real person.

Referring to FIG. 2F, at step 221, the micromodeling platform 102 may output a display for supplementary authentication. For example, the micromodeling platform 102 may cause output, at the user device 104, of a display requesting supplementary authentication from the user of the user device 104 in order to process the event processing request. The display for supplementary authentication may include one or more instructions for actions to be performed by the user in order to authenticate the user. In some examples, the display may be a user interface. In causing display of such a user interface, the micromodeling platform 102 may cause display of a graphical user interface similar to supplementary authentication interface 320, which is illustrated in FIG. 3C. For example, the micromodeling platform 102 may output one or more instructions (via the communication interface 113 and while the first wireless data connection is established) to the user device 104, causing the user device 104 to display the supplementary authentication interface 320.

Referring to FIG. 3C, in some instances, the supplementary authentication interface 320 may include information requesting the user of the user device 104 to provide supplementary authentication information. For example, the supplementary authentication interface 320 may include information such as a request for the user to provide a specific gesture via a camera or similar component of the user device 104, a request for the user to move (e.g., with a cursor, with a virtual reality handset, with a neural link control, and/or by other means) an object from one area of a screen of the user device 104 to another area of the screen, a request for the user to speak a particular phrase, and/or other information. The supplementary authentication interface 320 may also display interface elements or selectable options requesting user input. For example, the supplementary authentication interface 320 may display one or more of: an information entry field, a button or buttons, toggle or toggles, check box or boxes, a window mirroring a view of the camera of the user device 104, and/or other interface elements. For example, as illustrated in FIG. 3C, the interface elements may be a window 322 mirroring a view of the camera of the user device 104 that the user might use to present a requested gesture (e.g., raise an eyebrow, give a thumbs up, and/or other gestures). Also or alternatively, the interface elements may be a graphical display 324 for moving an object across an area of a screen or other display. In some instances, based on a user providing user feedback (e.g., supplementary authentication information), the user device 104 may provide the feedback to the micromodeling platform 102 as an authentication result and the micromodeling platform 102 may receive the user input/feedback (e.g., as an authentication result, as described herein with respect to step 222).

Referring again to FIG. 2F, at step 222, the micromodeling platform 102 may receive an authentication result. For example, the micromodeling platform 102 may receive an authentication result from the user device 104 based on outputting the display for supplementary authentication. The authentication result may be and/or include user feedback, received by the user device 104 in response to outputting the display for supplementary authentication. For example, the authentication result may be an indication of which direction the user moved an object on a screen or virtual reality display, an indication of a final location of an object the user moved on a screen or virtual reality display, a facial scan or similar information indicating a gesture the user provided, a voice recording or similar information indicating a phrase or term the user spoke, and/or other information.

At step 223, the micromodeling platform 102 may respond to the event processing request. The micromodeling platform 102 may respond to the event processing request by sending (e.g., via the communication interface 113 and while the first wireless data connection is established) a response to the user device 104. In some examples, based on identifying that the similarity score met or exceeded the threshold, the micromodeling platform 102 may respond to the event processing request by processing the event processing request and sending a confirmation that the request was processed to the user device 104 and/or by providing request information to the user device 104. In some examples, the micromodeling platform 102 may respond to the event processing request based on the authentication result. For example, based on an authentication result indicating that the user correctly performed a requested action (e.g., moved an object to the requested location, spoke a requested phrase, or the like), the micromodeling platform 102 may identify that the user provided supplementary authentication information that indicates the event processing request is not a deepfake attack. In these examples, the micromodeling platform 102 may respond to the event processing request by processing the event processing request and sending a confirmation that the request was processed to the user device 104 and/or by providing request information to the user device 104. Based on an authentication result indicating that the user incorrectly performed a requested action, the micromodeling platform 102 may identify that the user failed to provide supplementary authentication information that indicates the event processing request is not a deepfake attack. In these examples, the micromodeling platform 102 may respond to the event processing request by sending a message denying the event processing request, blocking access for the user device 104 to the micromodeling platform 102, reporting the user device 104 to a security center (e.g., via security device 106), and/or otherwise rejecting the event processing request.

At step 224, the micromodeling platform 102 may update the detection model. For example, the micromodeling platform 102 may update the detection model based on sending the response to the event processing request. In updating the detection model, the micromodeling platform 102 may refine, validate, and/or otherwise update the detection model to improve its performance of functions as described herein. For example, the micromodeling platform 102 may update the detection model by providing the authentication result as training input. The detection model may use machine learning techniques to modify its behaviors, algorithms, or the like based on the authentication result. By inputting the authentication result into the detection model, the micromodeling platform 102 may create and/or update an iterative feedback loop that may continuously and dynamically refine the detection model to improve its accuracy in generating similarity scores. In some instances, updating the detection model may include causing the detection model to update or add one or more stored correlations. For example, the micromodeling platform 102 may cause the detection model to store new correlations and/or update existing correlations such that the detection model may generate similarity scores, based on additional sample information included in the authentication result (e.g., gestures performed by the user, phrases or terms spoken by the user, or the like), in future iterations of the feedback loop.

In updating the detection model, the micromodeling platform 102 may improve the accuracy of the model for generating similarity scores and thus identifying deepfake attacks which may, for example, result in more efficient training of machine learning models trained by the micromodeling platform 102 (and may in some instances, conserve computing and/or processing power/resources in doing so). The improvements to the accuracy of the model may also provide improvements to the security of the network 101 by increasing the likelihood of the detection model successfully detecting deepfake attacks associated with future event processing requests.

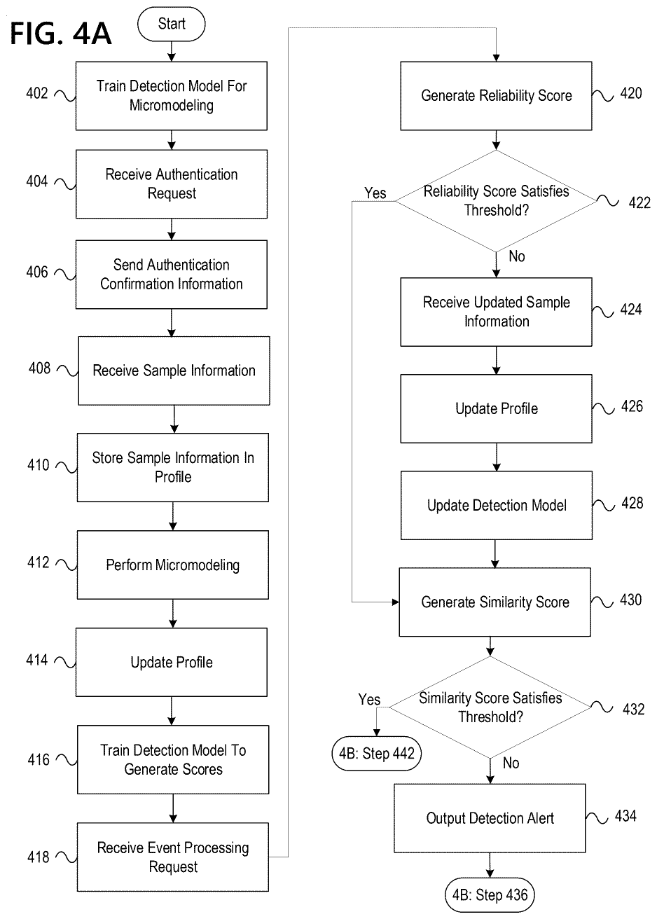

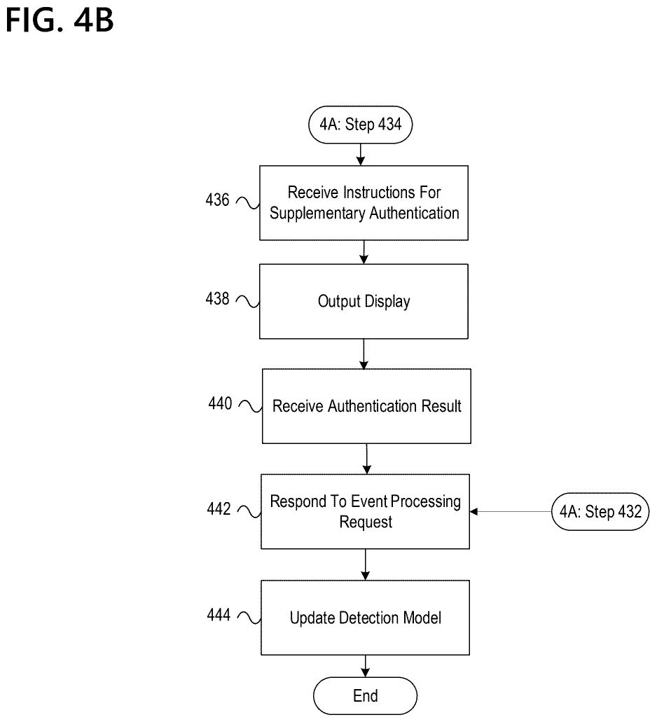

FIGS. 4A-4B depict an illustrative method for deepfake detection using micromodeling in accordance with one or more example arrangements. Referring to FIG. 4A, at step 402, a computing platform having at least one processor, a communication interface, and memory may train a detection model for micromodeling. For example, the computing platform may train a detection model to perform micromodeling based on input of sample information. At step 404, the computing platform may receive an authentication request. At step 406, the computing platform may send authentication confirmation information. At step 408, the computing platform may receive sample information. For example, the computing platform may receive facial recognition information, voice recognition information, and/or other information for performing micromodeling. At step 410, the computing platform may store the sample information in a profile.

At step 412, the computing platform may perform micromodeling. For example, the computing platform may perform micromodeling by inputting the sample information into the detection model to generate micromodeling information. At step 414, the computing platform may update the profile based on the micromodeling information. At step 416, the computing platform may train the detection model to generate scores. For example, the computing platform may train the detection model to generate reliability scores for micromodeling information and to generate similarity scores based on input of authentication information for event processing requests. At step 418, the computing platform may receive an event processing request. At step 420, the computing platform may generate a reliability score. For example, the computing platform may generate the reliability score using the detection model. At step 422, the computing platform may identify whether the reliability score satisfies a threshold.

At step 424, based on identifying that the reliability score does not satisfy the threshold, the computing platform may receive updated sample information. At step 426, the computing platform may update the profile based on the updated sample information. At step 428, the computing platform may update the detection model. For example, the computing platform may update the detection model based on the updated sample information. At step 430, the computing platform may generate the similarity score. In some examples, the computing platform may generate the similarity score based on identifying that the reliability score satisfies the threshold score at step 422. The computing platform may generate the similarity score by inputting authentication information for the event processing request into the detection model. At step 432, the computing platform may identify whether the similarity score satisfies the threshold. At step 434, based on identifying that the similarity score does not satisfy the threshold, the computing platform may output a detection alert.

Referring to FIG. 4B, at step 436, the computing platform may receive instructions for supplementary authentication. At step 438, the computing platform may output a display. For example, the computing platform may output a display requesting supplementary authentication from a user. At step 440, the computing platform may receive an authentication result. At step 442, the computing platform may respond to the event processing request. In some examples, the computing platform may respond to the event processing request based on identifying that the similarity score satisfies the threshold score at step 432 in FIG. 4A. In some examples, the computing platform may respond to the event processing request based on receiving the authentication result. At step 444, the computing platform may update the detection model.

One or more aspects of the disclosure may be embodied in computer-usable data or computer-executable instructions, such as in one or more program modules, executed by one or more computers or other platforms to perform the operations described herein. Generally, program modules include routines, programs, objects, components, data structures, and the like that perform particular operations or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various arrangements. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative arrangements, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative arrangements thereof. Numerous other arrangements, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, configure the computing platform to:
train, based on historical sample information, a detection model to perform micromodeling based on input of sample information;
receive, from a user device, sample information for identification of a user;
generate, based on the sample information, by performing micromodeling using the detection model, micromodeling information, wherein the micromodeling information comprises a plurality of clusters of sample information associated with the user;
train, based on the micromodeling information, the detection model to output similarity scores based on input of authentication information for event processing requests;
receive, from the user device, an event processing request;
generate, based on the event processing request, using the detection model, a similarity score indicating a similarity between authentication information of the event processing request and the micromodeling information;
identify, by comparing the similarity score to a first threshold score, whether the similarity score satisfies the first threshold score, and in response:
based on identifying that the similarity score does not satisfy the first threshold score, cause display of a detection alert indicating a potential cyberthreat; and
based on identifying that the similarity score does satisfy the first threshold score, indicate approval of the event processing request;
send, based on identifying whether the similarity score satisfies the first threshold score, a response to the event processing request; and
update, based on sending the response to the event processing request, the detection model.

2. The computing platform of claim 1, wherein the memory stores additional computer-readable instructions that, when executed by the at least one processor, configure the computing platform to:
train, based on the micromodeling information, the detection model to output reliability scores based on input of authentication information for event processing requests;
generate, based on the event processing request, using the detection model, a reliability score for at least one cluster of the plurality of clusters; and
identify, by comparing the reliability score to a second threshold score, whether the reliability score satisfies the second threshold score, and in response:
based on identifying that the reliability score does not satisfy the second threshold score, output a request for new sample information; and
generate, further based on identifying that the reliability score does satisfy the second threshold score, the similarity score.

3. The computing platform of claim 2, wherein the memory stores additional computer-readable instructions that, when executed by the at least one processor, configure the computing platform to:
cause display, at the user device, of a user interface comprising the request for new sample information;
receive, from the user device, the new sample information; and
update, based on the new sample information, the detection model.

4. The computing platform of claim 1, wherein training the detection model to perform micromodeling comprises:
identifying, based on the historical sample information, a plurality of categories of scored user information; and
training, based on the plurality of categories of scored user information, the detection model to cluster sample information,
wherein training the detection model to cluster sample information comprises training the detection model to assign weights for clusters of sample information corresponding to different categories, of the plurality of categories, of scored user information.

5. The computing platform of claim 1, wherein the historical sample information comprises one or more of:
voice recognition information; or
facial recognition information.

6. The computing platform of claim 1, wherein the memory stores additional computer-readable instructions that, when executed by the at least one processor, configure the computing platform to:
receive, from the user device, an authentication request; and
send, to the user device, authentication information for authentication confirmation of the computing platform, wherein the authentication information comprises a zero-knowledge authentication parameter.

7. The computing platform of claim 6, wherein the authentication request comprises one or more of:
a virtual reality interaction request;
a neural link request; or
a video conference request.

8. The computing platform of claim 1, wherein the sample information comprises geolocation information.

9. The computing platform of claim 1, wherein the sample information comprises facial recognition information.

10. The computing platform of claim 1, wherein the sample information comprises voice recognition information.

11. The computing platform of claim 1, wherein the memory stores additional computer-readable instructions that, when executed by the at least one processor, configure the computing platform to:
store the sample information in a user profile in a database,
wherein the performing micromodeling comprises accessing, in the database, the sample information;
update, based on the micromodeling information, the user profile; and
update, based on the user profile, the detection model.

12. The computing platform of claim 1, wherein the performing the micromodeling comprises:
identifying, based on the sample information, a plurality of categories of sample information;
assigning, based on the plurality of categories, one or more weights to portions of the sample information; and
generating, based on the plurality of categories and the assigned one or more weights, the plurality of clusters of sample information.

13. The computing platform of claim 1, wherein the plurality of clusters of sample information comprises one or more of:
a cluster of geolocation information;
a cluster of facial expressions; or
a cluster of vocal traits.

14. The computing platform of claim 1, wherein the memory stores additional computer-readable instructions that, when executed by the at least one processor, configure the computing platform to:
receive, based on causing display of the detection alert, at least one instruction for requesting supplementary authentication;
cause, at the user device, display of a user interface for receiving supplementary authentication;
display, on the user interface, a request for the user to perform an action;
receive, based on displaying the request for the user to perform the action, an authentication result; and
wherein the response to the event processing request is based on the authentication result.

15. A method comprising:
at a computing device comprising at least one processor, a communication interface, and memory:
training, based on historical sample information, a detection model to perform micromodeling based on input of sample information;
receiving, from a user device, sample information for identification of a user;
generating, based on the sample information, by performing micromodeling using the detection model, micromodeling information, wherein the micromodeling information comprises a plurality of clusters of sample information associated with the user;
training, based on the micromodeling information, the detection model to output similarity scores based on input of authentication information for event processing requests;
receiving, from the user device, an event processing request;
generating, based on the event processing request, using the detection model, a similarity score indicating a similarity between authentication information of the event processing request and the micromodeling information;
identifying, by comparing the similarity score to a first threshold score, whether the similarity score satisfies the first threshold score, and in response:
based on identifying that the similarity score does not satisfy the first threshold score, causing display of a detection alert indicating a potential cyberthreat; and
based on identifying that the similarity score does satisfy the first threshold score, indicating approval of the event processing request;
sending, based on identifying whether the similarity score satisfies the first threshold score, a response to the event processing request; and
updating, based on sending the response to the event processing request, the detection model.

16. The method of claim 15, further comprising:
training, based on the micromodeling information, the detection model to output reliability scores based on input of authentication information for event processing requests;
generating, based on the event processing request, using the detection model, a reliability score for at least one cluster of the plurality of clusters; and
identifying, by comparing the reliability score to a second threshold score, whether the reliability score satisfies the second threshold score, and in response:
based on identifying that the reliability score does not satisfy the second threshold score, outputting a request for new sample information; and
generating, further based on identifying that the reliability score does satisfy the second threshold score, the similarity score.

17. The method of claim 15, further comprising:
receiving, based on causing display of the detection alert, at least one instruction for requesting supplementary authentication;
causing, at the user device, display of a user interface for receiving supplementary authentication;
displaying, on the user interface, a request for the user to perform an action;
receiving, based on displaying the request for the user to perform the action, an authentication result; and
wherein the response to the event processing request is based on the authentication result.

18. One or more non-transitory computer-readable media storing instructions that, when executed by a computing platform comprising at least one processor, a communication interface, and memory, configure the computing platform to:
train, based on historical sample information, a detection model to perform micromodeling based on input of sample information;
receive, from a user device, sample information for identification of a user;
generate, based on the sample information, by performing micromodeling using the detection model, micromodeling information, wherein the micromodeling information comprises a plurality of clusters of sample information associated with the user;
train, based on the micromodeling information, the detection model to output similarity scores based on input of authentication information for event processing requests;
receive, from the user device, an event processing request;
generate, based on the event processing request, using the detection model, a similarity score indicating a similarity between authentication information of the event processing request and the micromodeling information;
identify, by comparing the similarity score to a first threshold score, whether the similarity score satisfies the first threshold score, and in response:
based on identifying that the similarity score does not satisfy the first threshold score, cause display of a detection alert indicating a potential cyberthreat; and
based on identifying that the similarity score does satisfy the first threshold score, indicate approval of the event processing request;
send, based on identifying whether the similarity score satisfies the first threshold score, a response to the event processing request; and
update, based on sending the response to the event processing request, the detection model.

19. The one or more non-transitory computer-readable media of claim 18, storing additional instructions that, when executed, further configure the computing platform to:
train, based on the micromodeling information, the detection model to output reliability scores based on input of authentication information for event processing requests;
generate, based on the event processing request, using the detection model, a reliability score for at least one cluster of the plurality of clusters; and
identify, by comparing the reliability score to a second threshold score, whether the reliability score satisfies the second threshold score, and in response:
based on identifying that the reliability score does not satisfy the second threshold score, output a request for new sample information; and
generate, further based on identifying that the reliability score does satisfy the second threshold score, the similarity score.

20. The one or more non-transitory computer-readable media of claim 18, storing additional instructions that, when executed, further configure the computing platform to:
receive, based on causing display of the detection alert, at least one instruction for requesting supplementary authentication;
cause, at the user device, display of a user interface for receiving supplementary authentication;
display, on the user interface, a request for the user to perform an action;
receive, based on displaying the request for the user to perform the action, an authentication result; and
wherein the response to the event processing request is based on the authentication result.
